(19) United States
(12) Patent Application Publication
(10) Pub. No.: US 2025/0144668 A1
(43) Pub. Date: May 8, 2025

(54) SYSTEMS AND METHODS FOR MANUFACTURING AND DEPOSITING NANO-SCALE MATERIALS

(71) Applicant: BATTELLE SAVANNAH RIVER ALLIANCE, LLC, AIKEN, SC (US)

(72) Inventors: SIMONA E. HUNYADI MURPH, NORTH AUGUSTA, SC (US); VAHID MAJIDI, AIKEN, SC (US)

(21) Appl. No.: 18/940,963

(22) Filed: Nov. 8, 2024

Related U.S. Application Data
(60) Provisional application No. 63/597,050, filed on Nov. 8, 2023.

(51) Int. Cl. B05D 3/00; B05D 1/02

(52) U.S. Cl. CPC B05D 3/203; B05D 1/02

(57) ABSTRACT

The present invention is directed to a system for manufacturing and depositing nano-scale materials and a corresponding method. The system may include a first capillary, a second capillary, a first mixing region, and a deposition subsystem. The deposition subsystem may include a print head and a modified atomic force microscope subsystem. The modified atomic force microscope subsystem may include a modified atomic force microscope tip having an aperture for depositing nano-scale materials.

### RELATED APPLICATIONS

The present application is based upon and claims priority to U.S. Provisional Patent Application Ser. No. 63/597,050, having a filing date of Nov. 8, 2023, which is incorporated herein by reference in its entirety.

### FEDERAL RESEARCH STATEMENT

This invention was made with government support under Contract No. 89303321CEM000080, awarded by the U.S. Department of Energy. The government has certain rights in the invention.

### BACKGROUND OF THE INVENTION

The patterning of particles (e.g., colloidal particles) in precisely organized architectures has attracted intense research interest for decades. Generally, this is due to their potential applications in flexible electronics, magnetic and optical devices, sensors, biotechnology, communications, etc. Notably, the most common surface patterning techniques, including nanoimprinting, nanografting, or a combination of nanolithography techniques coupled with chemical approaches, generate micrometer and submicrometer-sized architectures. Unfortunately, these approaches either lack the required surface coverage or utilize a specialized and costly print/stamp technology in achieving the patterning of nanoparticle arrays on surfaces. Additionally, these approaches can involve significant complexity due to the interplay of various factors such as granularity, defects, collective behavior, fluctuations, variations, and structural and dynamic heterogeneity. Notably, these elements are important in the development of advanced materials like photonic, plasmonic, spintronic, and metamaterials. In order to make strides in this field, new approaches to synthesis, fabrication, and analysis are needed.

Thus, there is a need to provide an improved particle formation system, and more particularly a need to provide an improved particle formation system including a modified atomic force microscope tip.

### SUMMARY OF THE INVENTION

Aspects and advantages of the invention will be set forth in part in the following description, or may be obvious from the description, or may be learned through practice of the invention.

In accordance with one aspect of the present invention, a system for manufacturing and depositing nano-scale materials is disclosed. The system may comprise: a first capillary having a first end and a second end and an inner diameter of about 1500 μm or less; a second capillary; a first mixing region; a first pump configured to pump a first fluid through the first capillary in a direction from the first end to the second end of the first capillary; a second pump configured to pump a second fluid through the second capillary in a direction from a first end to a second end of the second capillary; a deposition subsystem, the deposition subsystem comprising: a print head; and a modified atomic force microscope subsystem, the modified atomic force microscope subsystem being in fluid communication with the first mixing region, the modified atomic force microscope subsystem comprising a cantilever and a modified atomic force microscope tip, the modified atomic force microscope tip comprising an outlet for depositing a nano-scale material.

In accordance with one aspect of the present invention, a method for manufacturing and depositing nano-scale materials is disclosed. The method may comprise: flowing a first fluid carrying a first reagent through a first capillary; flowing a second fluid carrying a second reagent through a second capillary, the first fluid and the second fluid passing into a first mixing region, the first reagent and second reagent interacting within the first mixing region to form a nano-scale material; flowing the nano-scale material to a deposition subsystem, the deposition subsystem comprising a print head and a modified atomic force microscope subsystem, the modified atomic force microscope subsystem being in fluid communication with the first mixing region, the modified atomic force microscope subsystem comprising a cantilever and a modified atomic force microscope tip, the modified atomic force microscope tip comprising an outlet for depositing a nano-scale material; and depositing the nano-scale material from the modified atomic force microscope subsystem to a print bed.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of a formation system in accordance with aspects of the present disclosure;

FIG. 2 illustrates a portion of the formation system of FIG. 1;

FIG. 3 illustrates multiple mixing regions in accordance with aspects of the present disclosure;

FIG. 4 illustrates multiple mixing regions in accordance with aspects of the present disclosure;

FIG. 5 illustrates multiple mixing regions in accordance with aspects of the present disclosure;

FIG. 6 illustrates a deposition subsystem in accordance with aspects of the present disclosure;

FIG. 7A illustrates a modified atomic force microscope subsystem in accordance with aspects of the present disclosure;

FIG. 7B illustrates a modified atomic force microscope subsystem in accordance with aspects of the present disclosure;

FIG. 7C illustrates a modified atomic force microscope subsystem in accordance with aspects of the present disclosure;

FIG. 8 illustrates a modified atomic force microscope subsystem in accordance with aspects of the present disclosure; and

FIG. 9 illustrates a cantilever and a modified atomic force microscope tip of a modified atomic force microscope subsystem in accordance with aspects of the present disclosure.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a system for manufacturing and depositing nano-scale materials. The system may include a modified atomic force microscope subsystem. Notably, the system may provide precise and consistent control and special arrangement of nanomaterials (e.g., functional nanomaterials). Further, the system may have improved spatial resolution and improved deposition profile. The versatility of the system may be demonstrated by the ability to pattern nanoparticles with different dimensions, shapes, and compositions, tethered with various functionalities and subjected to different external stimuli.

Notably, the system may include a full-scale, automated Nano-Additive Manufacturing (NAM) technology that couples Automated Flow-Throughput Domain Processing (AFTDP) nanomaterial (NM) fabrication, and 3D nano-manufacturing technologies. Generally, the system may include surface functionalization/recognition, template directed self-assembly, electric fields, magnetic fields, or a combination thereof.

In some aspects, disclosed methods can be utilized to deposit materials (e.g., nano-scale materials) formed according to methods described in US Patent Application Publication No. 2021/0380405, which is incorporated herein by reference in its entirety.

It should be understood that throughout the entirety of this specification, each numerical value disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present disclosure may omit one or more of the features disclosed herein.

### Deposition Subsystem

A formation system in accordance with the present disclosure may include a deposition subsystem. The deposition subsystem may include a print head and a modified atomic force microscope subsystem. The modified atomic force microscope subsystem may have a cantilever and a modified atomic force microscope tip. In some aspects, the deposition subsystem may include a plurality of print heads and/or a plurality of modified atomic force microscope subsystems. Notably, in some aspects, a print head may include two or more modified atomic force microscope subsystems.

Generally, atomic force microscopy is used for topographic imaging and force spectroscopy. With respect to force spectroscopy, atomic force microscopy may be used to determine various properties of a sample, such as the hardness of a sample. The present inventors have discovered that an aperture may be formed in an atomic force microscopy tip to create a nozzle capable of precise and consistent control and special arrangement of materials (e.g., nano-scale material). In this respect, the nozzle of the present disclosure may be a modified atomic force microscope tip having an aperture such that a material (e.g., nano-scale material) can exit the modified atomic force microscope tip and be applied to or deposited on a surface (e.g., print bed). Notably, a print bed or a substrate carried on a print bed can be of any suitable material for receiving the nanoparticles. For instance, nano-scale material may be deposited on a print bed or surface comprising quartz, metal (gold, copper, silver, etc.), metal alloy (steel, stainless steel, bronze, etc.), polymers, ceramic, textile (e.g., wool, silk, cotton, bamboo, etc.), metallic colloids, hybrid colloids, or any other desired material.

In general, the print head may be in fluid communication with one or more mixing regions. In some aspects, the print head may be positioned after the mixing region or downstream from the mixing region. Notably, the print head may be configured to have an atomic force microscope subsystem mounted or attached thereto. For instance, a print head may have an end portion for receiving an atomic force microscope subsystem. The end portion of a print head may have a substantially circular or rectangular configuration.

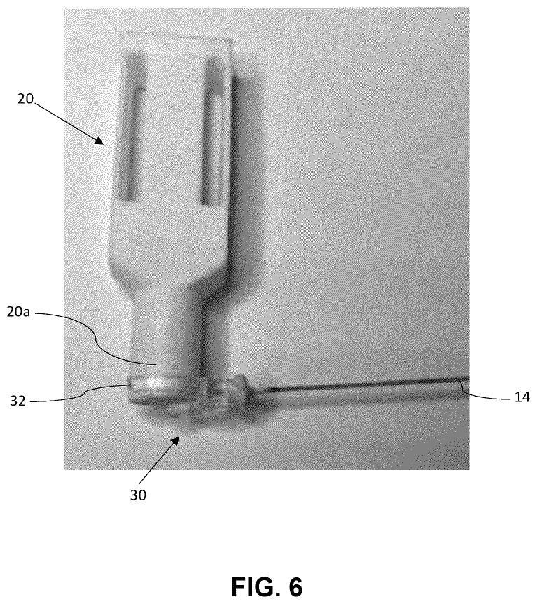

Referring now to FIG. 6, FIG. 6 illustrates a print head 20 connected to a modified atomic force microscope subsystem 30. Notably, the end portion 20a of the print head 20 of FIG. 6 has a substantially circular configuration that receives the modified atomic force microscope subsystem 30. As illustrated, in FIG. 6, a modified atomic force microscope subsystem 30 may be in fluid communication with an outside capillary 14. Notably, the modified atomic force microscope subsystem 30 may include one or more mounts 32 for mounting or attaching the modified atomic force microscope subsystem 30 to an end portion 20a of a print head 20. It should be understood that a modified atomic force microscope subsystem may be in fluid communication with one or more capillaries, such as any of the capillaries disclosed herein. Further, it should be understood that a modified atomic force microscope tip may be in fluid communication with one or more capillaries, such as any of the capillaries disclosed herein. It should be understood that a modified atomic force microscope subsystem may be in fluid communication with one or more mixing regions, such as any of the mixing regions disclosed herein. Further, it should be understood that a modified atomic force microscope tip may be in fluid communication with one or more mixing regions, such as any of the mixing regions disclosed herein.

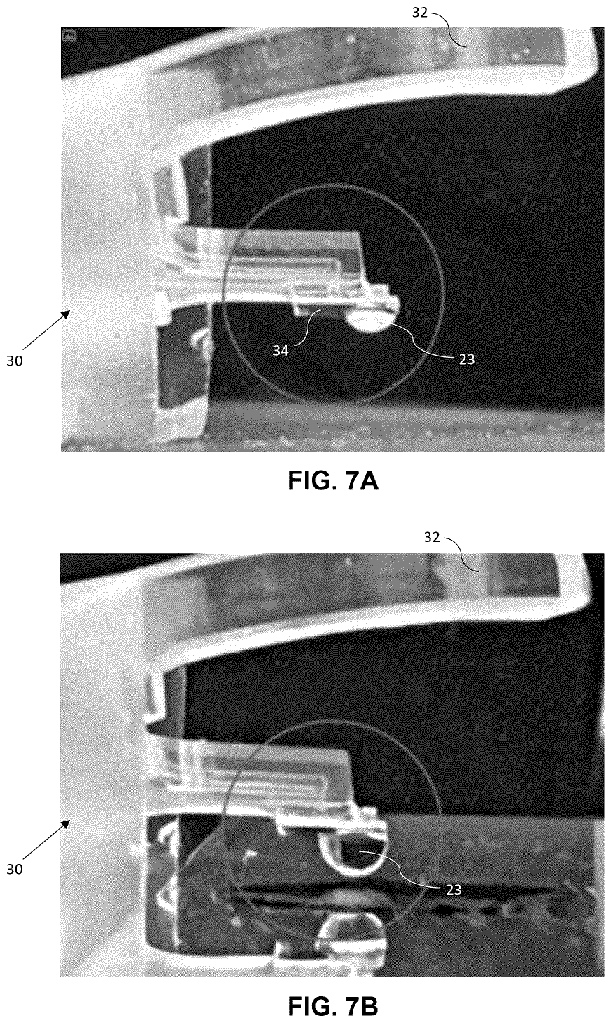

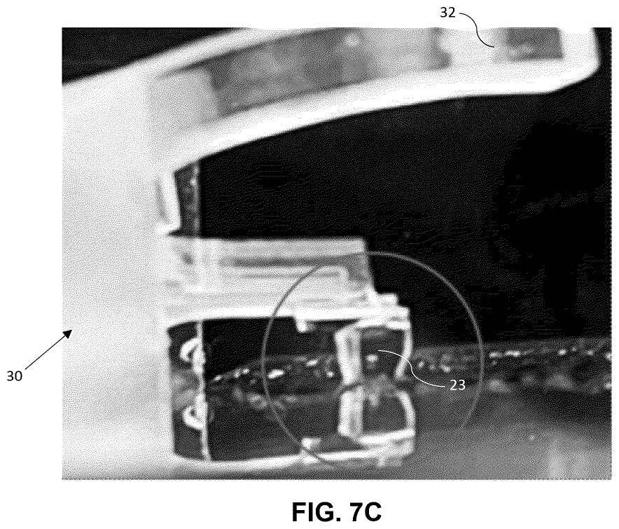

Referring now to FIGS. 7A-7C, FIGS. 7A-7C illustrate a time-lapse of a droplet of nano-scale material 23 forming and being deposited on a surface. Further, FIGS. 7A-7C illustrate a mount 32. Notably, the red circles in FIGS. 7A-7C are included to further illustrate the location of the droplet of nano-scale material 23.

Referring now to FIG. 7A, FIG. 7A illustrates one aspect of a modified atomic force microscope subsystem 30 forming a droplet of nano-scale material 23. FIG. 7A further illustrates a cantilever 34 of the modified atomic force microscope subsystem 30. Notably, in FIG. 7A, a droplet of nano-scale material 23 has formed from the modified atomic force microscope tip.

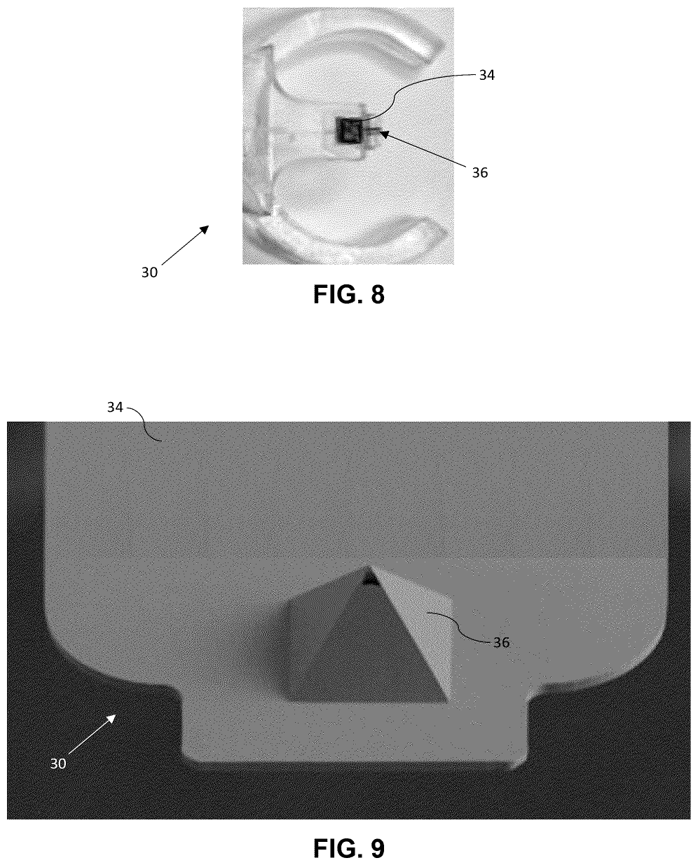

Referring now to FIG. 8, FIG. 8 illustrates a cantilever 34 and a modified atomic force microscope tip 36 of a modified atomic force microscope subsystem 30. Referring now to FIG. 9, FIG. 9 illustrates an enhanced view of the cantilever 34 and the modified atomic force microscope tip 36 of a modified atomic force microscope subsystem 30 as illustrated in FIG. 8. Notably, FIG. 8 and FIG. 9 are bottom views of a modified atomic force microscope subsystem 30. In this respect, the atomic force microscope tip 36 of FIG. 8 and FIG. 9 is oriented toward the viewer.

In general, a modified atomic force microscope tip may comprise or be formed at least partially from a non-reactive material. In some aspects, a modified atomic force microscope tip may comprise or be formed at least partially from a ceramic material. For instance, a ceramic material may include fused silica, silicon nitride, or a combination thereof.

Generally, the aperture or outlet of the modified atomic force microscope tip, and more generally the modified atomic force microscope subsystem, may have a diameter and/or a cross-sectional width from about 100 nm to about 50 μm, including all increments of 1 nm therebetween. In some aspects, an aperture or outlet of the modified atomic force microscope tip may have a diameter and/or a cross-sectional width of about 100 nm or more, such as about 200 nm or more, such as about 300 nm or more, such as about 500 nm or more, such as about 1 μm or more, such as about 2 μm or more, such as about 4 μm or more, such as about 6 μm or more, such as about 8 μm or more, such as about 10 μm or more, such as about 15 μm or more, such as about 25 μm or more. In some aspects, an aperture or outlet of the modified atomic force microscope tip may have a diameter and/or a cross-sectional width of about 50 μm or less, such as about 25 μm or less, such as about 15 μm or less, such as about 10 μm or less, such as about 8 μm or less, such as about 6 μm or less, such as about 4 μm or less, such as about 2 μm or less, such as about 1 μm or less, such as about 500 nm or less, such as about 300 nm or less, such as about 200 nm or less.

### Additional Disclosures

Generally, the formation system provides for precise control of reaction parameters and conditions, e.g., fluid flow rates, temperature, pressure, reaction zone volume, pH, ionic strength, etc., within and along all or a portion of the lengths of the micro-scale capillaries, and in particular, along lengths where the nano-scale products are formed. This control capability provides a route for the formation of nano-scale materials exhibiting complex designs and arrangements, including complex hybrid and multifunctional nano-scale structures of various shapes (stars, rods, triangles, pyramids, spheres, etc.). Because of the large surface area of the capillaries used to contain the formation reactions, heat transfer can be very efficient, allowing for excellent temperature control and maintenance of, e.g., constant temperature throughout a nanoparticle formation length of a capillary. In addition, the system provides a route for efficient and localized control of pressure, temperature, and fluid characteristics (e.g., pH, ionic content, etc.). Such excellent control capability improves product characteristics (e.g., monodispersity) and decreases the formation of waste products. As such, the system can be particularly beneficial in processes that involve toxic and/or particularly expensive compounds, as well as for use in challenging reactions, as the use of the system can produce little or no waste.

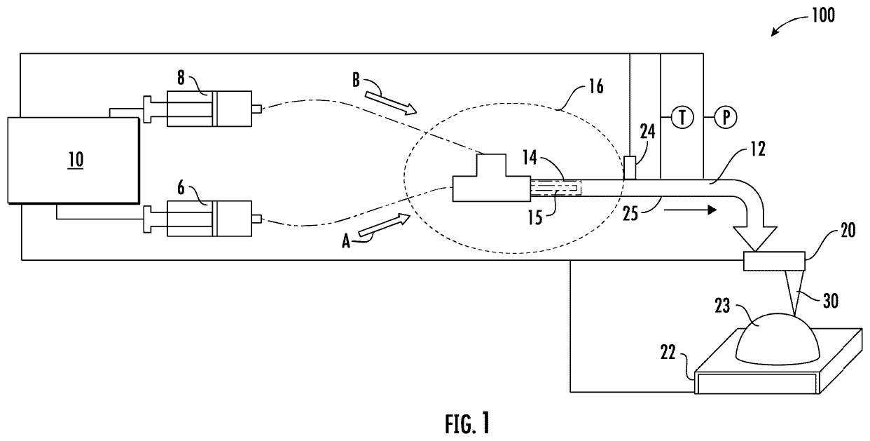

Referring now to FIG. 1, FIG. 1 illustrates one aspect of a formation system 100. It should be understood that the formation system may be referred to herein as a particle formation system. The formation system may include multiple capillaries that include capillaries for delivery of reactants to a reaction zone, as well as capillaries (which can be extensions of or different from the delivery capillaries), that define reaction zones within which the nano-scale structures are formed. As illustrated in FIG. 1, a formation system 100 can include at least one mixing region 12 that includes a length of at least one of the capillaries 14, 15 of the system.

As utilized herein, the term “capillaries” generally refers to hollow tubular structures. Notably, a capillary may have an inside diameter of about 1500 μm or less, such as about 1200 μm or less, such as about 1000 μm or less, such as about 800 μm or less, such as about 600 μm or less, such as about 400 μm or less, such as about 200 μm or less, such as about 100 μm or less, such as about 50 μm or less, such as about 25 μm or less, such as about 10 μm or less, such as about 1 μm or less, such as about 500 nm or less. In general, a capillary may have an inside diameter of about 100 nm or more, such as about 200 nm or more, such as about 500 nm or more, such as about 1 μm or more, such as about 10 μm or more, such as about 25 μm or more, such as about 50 μm or more, such as about 100 μm or more, such as about 200 μm or more, such as about 400 μm or more, such as about 600 μm or more, such as about 800 μm or more, such as about 1000 μm or more.

Notably, the capillaries of disclosed systems can be formed of nonporous materials that can be non-reactive to reagents, carrier fluids, etc. to be passed through the capillaries. The capillaries can also have relatively smooth inner surfaces that can avoid degradation of laminar flow over the surface. A system will also include capillaries for which flow will be both within and external to the capillary, and the outer surface of these capillaries can likewise be relatively smooth, so as to avoid degradation of laminar flow over the surface. In some embodiments, all capillaries of a system can be composed of the same materials, but this is not a requirement, and in other embodiments, multiple different capillary types and compositions can be utilized.

In one embodiment, a capillary can be composed of a glass, such as a silica glass, a borosilicate, or an aluminosilicate. In some embodiments, a capillary can be composed of a polymeric material, e.g., polyvinyl chloride (PVC), polymethylmethacrylate (PMMA), polytetrafluoroethylene (PTFE), polyimide (PI), polyethylene (PE), and the like. Coated capillaries are also encompassed herein, such as polymer-clad glass capillaries, e.g., polyimide-clad silica capillaries, as are available on the market. Silica capillaries can be utilized in one embodiment as they are known to exhibit broad material compatibility. Use of commercial off-the-shelf silica glass capillaries can reduce the overall cost of a system. Silica glass construction also can provide excellent flow stability, system rigidity, and surface quality. Glass capillary construction materials can also be useful in embodiments in which capillaries can exhibit dimensional transitions by thermal tapering along the length of the capillary.

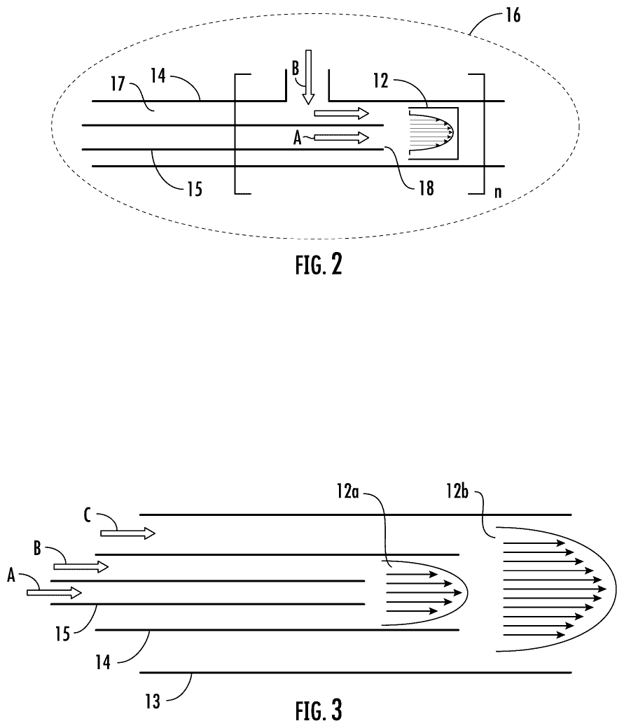

Notably, as illustrated in FIG. 1, the formation system 100 can include at least one area 16 within which reagents for the formation of nano-scale materials are delivered and combined. Area 16 of FIG. 1 is illustrated in more detail in FIG. 2. As illustrated in FIG. 2, an area 16 can include at least two concentric capillaries 14, 15. A first flow A can be provided within the inner of the two capillaries 15. The outer diameter of the inner of the two capillaries 15 is smaller than the inner diameter of the outer of the two capillaries 14, so as to create a flow space 17 between the two capillaries and within the outer capillary 14. Due to the small size of the capillaries 14, 15, upon initiation of flow through the system, the capillaries can be self-centering, and as such, will not require any concentric alignment or support mechanisms as are required in larger, e.g., millifluidic, systems.

As indicated, a first fluid flow A can be delivered through an inner capillary 15 and a second fluid flow B can be delivered through an outer capillary 14. Though illustrated as being fed to the side of the outer capillary, this is not a requirement of a system, and fluid flow can be delivered at any suitable point along the length or at a terminus of any capillary of a system. The inner capillary 15 can include a termination 18 within the outer capillary 14, upon which the contents of the two fluids A, B can continue through the outer capillary 14 along a mixing region 12.

A mixing region 12 can be of any suitable length, generally about 10 centimeters or longer; for instance, up to several meters in some embodiments. The length of a mixing region 12 and the flow rate through a mixing region 12 can be varied to control the parameters of a formation process. In particular, the length of a mixing region 12 in combination with the flow rate through the region can define the mixing time, and hence, the reaction time between the reagents of the various fluids. For instance, a longer mixing region 12 can ensure a longer mixing/reaction period, which can lead to better control over the geometry and uniformity of the final nano-scale material, as the longer mixing time can ensure complete reaction of a limiting reagent.

As indicated, the flow along a mixing region 12 can exhibit a laminar flow pattern. A laminar flow pattern is one in which the viscous forces of the fluid dominates and the Reynolds number (Re) is less than about 2000. The Reynolds number represents the ratio of inertial forces to viscous forces and is represented by the following relationships:

$$Re = \frac{ρ uL}{μ} = \frac{uL}{v}$$

in which:
   ρ is the density of the fluid
   u is the velocity of the fluid with respect to the capillary
   L is a characteristic linear dimension
   μ is the dynamic viscosity of the fluid
   ν is the kinematic viscosity of the fluid

The Reynolds number of fluid flow along a mixing region 12 can be about 2000 or lower; for instance, about 1500 or lower, about 1000 or lower, about 500 or lower, or about 100 or lower in some embodiments.

The use of the small concentric capillaries encourages laminar flow within the mixing region 12, which in turn encourages faster and more complete physico-chemical processing of reagents carried in the fluids A and B that interact within the mixing region 12. The faster and more complete processing is understood to be due to the small reaction volumes, which is defined about the interfacial area of the mixing flows along the mixing region 12, which facilitates a more efficient thermal and mass transfer, leading to a more efficient formation reaction. Efficient formation of nanoparticles depends upon the ability to control the chemistries and local reaction environment as well as the ability to control the kinetic and thermodynamic factors that can affect the nanoparticle growth including the shape and ultimate size of the nanoparticles. The disclosed concentric capillary based systems provide for such control capabilities.

Generally, one or more pumps may be configured to pump one or more fluids from a first end of a capillary to a second end of a capillary, such as any of the capillaries disclosed herein. Referring again to FIG. 1, a system may include pumps 6, 8, that can be used to pump or deliver fluids A, B, respectively, to the concentric capillaries 14, 15, and thence to the mixing region 12. Pumps 6, 8 can deliver their respective fluids A, B to capillaries of a system at any desired flow rate and flow rate control can be utilized to control product characteristics including shape and size of product nano-scale structures as well as surface characteristics, e.g., surface functionality. In general, the flow rate of a fluid in a system can be on the order of nanoliters per minute (nL/min) or microliters per minute (□L/min), e.g., about 10 nL/min or more, about 100 nL/min or more, about 500 nL/min or more, about 1 □L/min or more, about 10 □L/min or more, or about 20 □L/min or more, in some embodiments. Generally, the flow rate of a fluid in a system can be about 1000 □L/min or less, about 500 □L/min or less, or about 100 □L/min or less. While the flow rate through all capillaries of a system can be identical, this is not a requirement of a system, and in some embodiments, flow rate through one capillary can differ from that in others. In addition, flow rate of the entire flow or a component of the flow through a capillary can be varied during a formation process, which can provide another control route for modifying/controlling aspects of a product or the product forming fluid, e.g., pH, etc. For instance, reagent flow through a capillary 14 can be stopped altogether for a portion of a formation process, while reagent flow continues in other areas of a system.

The fluids A, B can carry one or more reagents that, upon interaction in the mixing region, can form or modify a nano-scale material. In some embodiments, a system can include additional mixing regions and/or additional capillaries that can carry additional reagents. As such, the systems can be designed to form any type of nano-size structure, the formation of which includes the interaction of two or more different reagents either simultaneously or sequentially. Nanoparticle synthesis approaches can include, without limitation, chemical synthesis techniques such as seed mediated approaches or seedless formation approaches, self-assembly formation approaches, and galvanic displacement reactions; arrested precipitation synthesis techniques; solvothermal synthesis techniques; hydrothermal synthesis techniques; or combinations of formation techniques.

Generally, by way of example, particles as may be patterned by use of disclosed methods and systems can include, without limitation, mono-metallic and/or bimetallic particles such as Au/Fe/FexOy; Au—Co; Au—Ni, Au—Ru, Mg/MgO, Ta, Ir, etc. For example, disclosed systems and methods can be utilized in some embodiments with nanomaterials that include anisotropic, hybrid, and/or chiral components.

In general, a system may be utilized to form metallic nanoparticles within a mixing region via the reduction of a metal salt carried in one of the capillaries by the use of a reducing agent carried in another capillary. For instance, as illustrated in FIG. 1, a first solution A can carry a metal salt, e.g., a nitrate salt, a halogen salt, an oxide salt, etc. in an inner capillary 15, and a second solution B can carry a reducing agent in an outer capillary 14. Of course, the delivery of any particular reagent within an inner or outer capillary is not generally required, and any reagent can generally be delivered to a mixing region 12, such as the mixing region illustrated in FIG. 2, in either an inner or an outer capillary. Within the mixing region 12, reagents of the two solutions A, B can interact to form or modify a nano-scale structure.

The metal of metallic nanoparticles that can be formed by the use of disclosed systems is not particularly limited, provided a cation of the metal can be carried in a solution to a mixing region 12 and can be reduced by a reducing agent carried in a different solution to the mixing region 12. By way of example, a metal can be a transition metal including, without limitation, chromium (Cr), manganese (Mn), iron (Fe), cobalt (Co), nickel (Ni), or copper (Cu). In one embodiment, the metal can be a transition metal of the platinum group such as platinum (Pt), palladium (Pd), rhodium (Rh), ruthenium (Ru), silver (Ag), or gold (Au). Exemplary metal salts or metal compounds that can be used to deliver the metal of choice to a mixing region 12 can include, without limitation, silver nitrate, chloroauric acid (HAuCl₄xH₂O), potassium tetrachloroplatinate (II) (K₂PtCl₄), sodium tetrachloroplatinate (Na₂PdCl₄), cobalt acetate, manganese chloride, copper nitrate, nickel chloride, iron oxide, etc.

Any suitable reducing agent can be used to reduce the metal and form the metallic nanoparticles including, without limitation, sodium borohydride (NaBH₄), hydrazine (NH₂NH₂), lithium aluminum hydride (LiAlH₄), lithium triethylborohydride (LiEt₃BH), ascorbic acid, sodium citrate, alcohols, sugars (fructose, glucose, sucrose), dopamine, N,N-Dimethylformamide, or combinations of reducing agents.

One or both of the capillaries can carry additional supporting materials such as surfactants. Exemplary surfactants can include, without limitation, hexadecyltrimethylammonium bromide (CTAB), Gemini, dendrimers, bifunctional linkers, thiols, amines, ethylene glycol in the presence of poly (vinyl pyrrolidone). In some embodiments, a reducing agent can also function as a surfactant, e.g., CTAB, sodium citrate, polyacrylamide, and/or ethylene glycol.

A seed mediated approach can be used in one embodiment. A seed mediated approach can separate the nucleation and growth stages of a formation. For instance, a seed mediated approach can include the delivery of a seed material in a first capillary and the delivery of a growth solution (or a component of a growth solution) in a second concentric capillary. Seed material can include, for instance, metal seed particles such as those described above or any other seed particle of interest, e.g., oxides such as silica (SiO₂), titania (TiO₂), iron oxide (Fe₂O₃), zinc oxide (ZnO), alumina (Al₂O₃), in conjunction with a suitable metal salt, and a growth solution can include a reducing agent, with one or both solutions, optionally including other components such as surfactants or other stabilizers. For instance, a growth solution can include a reducing agent for a metal salt of a metal of the nanoparticles, a surfactant, and optionally other supporting reagents as are known in the art.

A seed mediated approach can be utilized in one embodiment to form hybrid nanoparticles. For instance, a seed material can differ from a material formed upon interaction of the reagents of the two flows A, B. By way of example, a seed particle can include an oxide, e.g., iron oxide, zinc oxide, or alumina, and this seed particle can be delivered in a first capillary in conjunction with a metal salt (e.g., silver nitrate or chloroauric acid). A second capillary can carry a reducing agent for the metal salt, e.g., sodium borohydride, and within the mixing region a hybrid nanoparticle, e.g., Fe₂O₃—Au can be formed.

As mentioned previously, a system is not limited to a single mixing area, and as illustrated in FIG. 2, a system can include multiple (n) sections that include the introduction of a fluid B carrying a reagent to a flow space 17 exterior to an inner concentric capillary 15 followed by a mixing region 12.

For example, in one embodiment as illustrated in FIG. 3, a system can include multiple concentric capillaries 13, 14, 15. A first fluid A that carries a first reagent can be delivered via inner capillary 15 and a second fluid B that carries a second reagent can be delivered via an intermediary capillary 14. Upon the termination of the inner capillary 15, the reagents carried in fluids A, B can interact in mixing region 12a for a predetermined length (reaction time). At the termination of the intermediary capillary 14, a second mixing region 12b can be initiated along which the resulting product of the first mixing region 12a can interact with reagent(s) in fluid flow C. Such a multi-stage formation process can be utilized to control the size/shape of a single material nanoparticle (e.g., a metal nanoparticle in which further mixing regions provide for the formation of a larger or differently shaped product) or to form a hybrid nanoparticle. By way of example, a first mixing region 12a can be utilized to form an intermediate particle, e.g., a first metal nanoparticle, and a second mixing region 12b can be utilized to modify that intermediate with a second material, e.g., a capping agent, a passivation agent, etc. to form a hybrid nanoparticle.

As mentioned, any nanoparticle formation process can be carried out by use of disclosed systems, some of which may lend themselves to multi-stage formation processes. For instance, in an arrested precipitation method, a first mixing region 12a can be utilized to encourage the nucleation of particles in an organic solvent and a second mixing region 12b can be utilized to arrest growth and agglomeration of the particles by the introduction of a suitable antisolvent. Arrested precipitation can be used in one embodiment to form nano-scale structures of semiconductor material such as silicon and selenium, as well as compound semiconductor materials such as oxides, sulfides, selenides, and phosphides of materials such as cadmium, indium, and zinc, examples of which can include, without limitation, CdO, CdS, CdSe, Cd₃P₂, In₂O₃, In₂S₃, In₂Se₃, InP, ZnO, ZnS, Zn₃P₂ and other compound materials such as lead sulfide (PbS) and lead selenide (PbSe).

A mixing region can be utilized for any desired single or multi-stage reaction chemistry, e.g., sol-gel procedures, solution chemistry formation procedures, etc. For instance, in one embodiment, a sol-gel formation process can be carried out in one or multiple mixing regions by which metal oxide, ceramic, or other nanoparticles can be formed, e.g., SiO₂ particles, TiO₂ particles, etc. For instance, in a first mixing region, monomers (e.g., a metal alkoxide) carried in solution in a first capillary can be combined with a suitable catalyst carried in a second capillary and can be converted to form a colloidal sol; for instance, via hydrolysis and polymerization (e.g., polycondensation). Following, for instance in a second mixing region, the sol can be further processed, for instance, via precipitation or gelling, to form highly uniform nano-sized particles. A sol-gel formation process may be desirable in certain embodiments; for instance, in forming nano-scale structures of ceramics, as the systems can process materials with a highly uniform distribution within the laminar flow of the mixing regions, which can encourage formation of monodisperse particles.

Solution chemistry processes that can include nucleation and growth under well-defined and controlled conditions possible within the concentric capillary systems are also encompassed. For instance, a multi-stage solution chemistry process can be carried out involving multiple mixing stages that can include a first mixing stage within which a metal salt delivered to the mixing stage from a first capillary can be combined with a precipitant carried in a second capillary so as to encourage nucleation. Growth of the nucleated materials can be carried out along the length of the first mixing region and controlled through the incorporation of a limiting reagent in the flow or alternatively, through modification of the growth solution in a downstream mixing region, e.g., through modification of the pH or temperature of the growth solution. Other variations and modifications of solution chemistry processes as would be evident to one of ordinary skill in the art are likewise encompassed herein.

Additional mixing regions can be included in a system for the addition of capping agents, surface passivation, surface functionalization, etc., or combinations thereof to a particle surface. Addition of a capping agent to a previously formed nanoparticle can be utilized to inhibit further growth of the nanoparticle, as in an arrested precipitation method, or can be utilized to merely modify a previously formed particle. Capping agents can include many organic and inorganic substances, including metals, oxides, polymers, etc., as are known in the art. Polymeric capping agents can be useful in arresting the growth of metal nanoparticles, as the polymeric chain can be strongly bound to metal ions near the surface of the nanoparticles. This binding can also encourage electrostatic repulsion between particles and can aid in keeping the nanoparticles apart sterically due to the presence of the polymeric chain. Examples of capping agents can include, without limitation, polymeric capping agents such as polyethylene glycol (PEG), ethylenediaminetetraacetic acid (EDTA), polyvinyl pyrrolidone (PVP) and polyvinyl alcohol (PVA), poly (diallyldimethylammonium chloride) (PDADMAC), polyallylamine hydrochloride (PAH), as well as copolymers such as polyethyleneoxide-polymethyl methacrylate (PEO-b-PMMA) block copolymer.

Surface functionality can be a further modification of initially formed nanoparticles in a further downstream section of a system. Surface functionalization can be useful for targeted deposition of the nanoparticles to a substrate (discussed further herein), for an end-use of the particles (e.g., targeted delivery in a system of use), or for any other useful purpose. Surface functionality as can be incorporated on the surface of a previously formed nanoparticle can include, without limitation, bifunctional linkers (e.g.,—SH, —OH, —COOH, —NH+, etc.), (3-mercaptopropyl) trimethoxysilane (MPTMS), (3-aminopropyl) triethoxysilane (APTES), sodium silicate, Titanium (IV) isopropoxide, thiols (sulfur ligands), amines, sodium silicate, aminothiols, hydrazine monohydrate, L-cysteine, thioacetamide, hydrogen peroxide, etc., as well as combinations of different surface functionalization.

Modification of the surface of previously formed nanoparticles, e.g., the addition of surface functionality, capping agents (partial or shell), etc. can be carried out in single or multiple steps. For instance, in a first modification step, the surface of a previously formed nanoparticle or the carrier fluid within the capillary can be modified through combination with a reagent, e.g., an acid (hydrochloric, nitric, ascorbic, sulfuric, phosphoric, etc.) or a base (ammonium hydroxide, sodium hydroxide, lithium hydroxide, etc.) in a mixing region and following, the modified mixture can be further processed in another mixing region, during which the surface modification (e.g., addition of surface functionality) can be completed. This modification can be followed by additional modification (e.g., linking of a polymeric capping agent to a previously added surface functionality) to form a further modified nanoparticle and/or controlled nanoparticle assemblies.

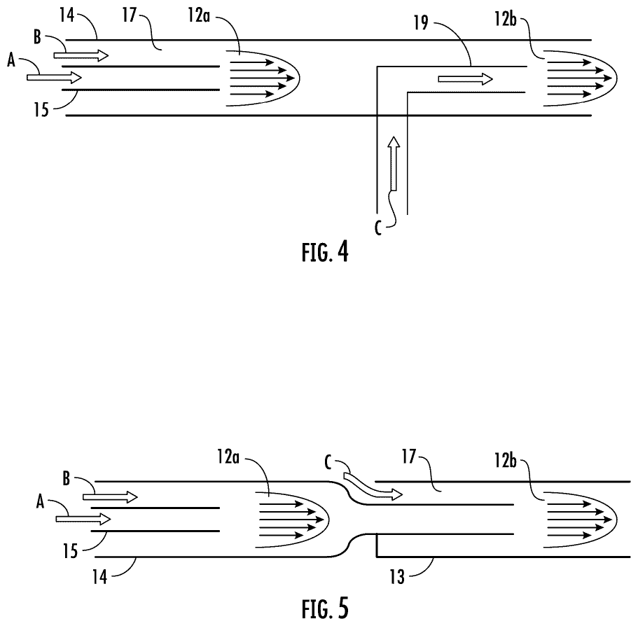

The manner of introducing additional mixing regions within a system is not particularly limited. For instance, in the embodiment of FIG. 3, the concentric capillaries 13, 14, 15 can all extend concentrically for a length, with inner capillaries terminating periodically along the length, thereby providing sequential mixing areas. In another embodiment, illustrated in FIG. 4, following a first mixing region 12a within which reagent(s) carried by flow A in capillary 15 interact with reagent(s) carried by flow B in the flow space 17 of capillary 14, capillary 19 can be introduced to the center of outer capillary 14. A flow C can be delivered to capillary 19 and at the termination of capillary 19 a second mixing region 12b can be established, in which the flow in the mixing region 12b exhibits a laminar flow field, as discussed.

Referring now to FIG. 5, FIG. 5 illustrates another embodiment of sequential mixing areas in a formation system. As illustrated, downstream of a first mixing region 12a within which the reagents of flow A and flow B, carried in capillaries 14, 15, respectively, have interacted, the outer diameter of capillary 14 can be decreased, as may be brought about by thermal tapering or the like. Following, another capillary 13 can be located so as to be concentric with the resulting smaller diameter capillary 14 and a flow C can deliver additional reagent(s) to the flow space 17 that is internal to capillary 13 and external to capillary 14. Following termination of the now internal capillary 14, a second mixing region 12b can extend within which a reagent carried in flow C can interact with the intermediate materials carried in capillary 14.

The input to a capillary system, e.g., flow C in FIG. 5, can in one embodiment be the result of interaction between flows of a parallel system, e.g., a parallel system as illustrated in FIG. 1. Thus, a system can include any number of combinations of parallel and series concentric flows and mixing regions and can provide any number of shapes, sizes and types of nano-scale structures.

Beneficially, a system can also include the capability for characterization of a flow at any point of a system. For instance, as illustrated in FIG. 1, a system can include on-line analysis capability 24 that can obtain information from within a mixing region 12 as illustrated or alternatively and/or additionally within one or more capillaries of a deposition subsystem. Any on-line analysis technique can be utilized including, without limitation, chemical analysis techniques, electromagnetic techniques, NMR analysis, photochemistry/optical analysis, on-line gas chromatography, UV-Vis spectroscopy, etc., as well as combinations of different techniques. As indicated in FIG. 1, in one embodiment, an on-line analysis technique 24 can be in communication with a control system 10, discussed in more detail herein.

As illustrated in FIG. 1, following the formation of nano-scale structures, the structures can be deposited in an approach based upon an additive manufacturing process. As illustrated in FIG. 1, and as previously disclosed herein, a formation system 100 may include a deposition subsystem including a print head 20 and a modified atomic force microscope subsystem 30 through which a nano-scale material 23 can be deposited to a print bed 22.

Notably, a deposition subsystem can include components such as actuators as are known in the art that are configured to move the print head 20 and/or the print bed 22 so as to provide motion relative to one another in at least one degree of freedom, e.g., two, three, four, five, six, or more degrees of freedom. As such, the nanoparticles can be deposited in a pattern that can be predefined and instigated by the use of a control system 10. Notably, in some aspects, the deposition subsystem may include piezoelectric actuators configured to move the print head 20 and/or the print bed 22. In some aspects, a piezoelectric actuator may generate pressure in a capillary (e.g., outside capillary) to deposit a nano-scale material on a surface (e.g., print bed).

Notably, a control system in accordance with the present disclosure may include a pico-motor interface. The pico-motor interface may be configured to operate or manage a pico-motor, which is generally capable of making precise movements at the pico-scale. Generally, a control system in accordance with the present disclosure may be configured to move a print head and/or a modified atomic force microscope subsystem in increments of 500 nm or less, such as 400 nm or less, such as 300 nm or less, such as 200 nm or less, such as 100 nm or less, such as 50 nm or less, such as 40 nm or less, such as 35 nm or less. Notably, the formation system of the present disclosure, and more particularly the print head and/or the modified atomic force microscope subsystem, may be configured to have a resolution of 500 nm or less, such as 400 nm or less, such as 300 nm or less, such as 200 nm or less, such as 100 nm or less, such as 50 nm or less, such as 40 nm or less, such as 35 nm or less. In this respect, the formation system of the present disclosure, and more particularly the print head and/or the modified atomic force microscope subsystem, may have a resolution of 500 nm increments or less, such as 400 nm or less, such as 300 nm or less, such as 200 nm or less, such as 100 nm or less, such as 50 nm or less, such as 40 nm or less, such as 35 nm or less.

A control system 10 may control other aspects of a system in addition to deposition parameters including, without limitation, flow rates through individual capillaries, temperature at one or more locations along the capillaries of a system, pressure at one or more locations along the capillaries of a system, content of flows within a system, etc. For instance, in one embodiment, a system can include multiple mixing regions, and each mixing region can be subject to independent temperature and pressure control by use of the control system 10. In one embodiment, temperature and/or pressure control can be provided by one or more tubes or capillaries 25 that are external to the capillaries carrying reagents and products of the system. Fluid within such one or more external tubes or capillaries 25 can be used to quickly modify/control the temperature and/or pressure within the capillary section(s) surrounded by the one or more tubes or capillaries 25. Of course, any other suitable temperature/pressure control system can be encompassed.

A control system 10 by which different areas of a system can be held at different conditions from one another can be highly beneficial. For instance, improved heat transfer, and thus, temperature control of disclosed systems, can prevent issues arising in previously known nanoparticle formation methodologies, such as crystallization issues. Similarly, different reaction conditions can be maintained in different areas to encourage desired reaction outcomes in each area. Moreover, improved control can provide for the separation of reagent mixing from reaction, which can be beneficial in some embodiments. For instance, a portion of a mixing region can be held at a reaction temperature, which differs from the initial temperature of the mixing region within which reagent mixing can occur. Similarly, pressure in a local area can apply stress within the capillaries, which can induce certain characteristics in the nanoparticles (e.g., stress-induced crystallization, enhanced structural arrangements, etc.). Applied stress during formation can also affect the free energy of the system, which can allow for tuning the phase or configuration of the nano-scale material, as the surface energy of the particles can play an important role in the phase transformation dynamics.

A control system 10 can include a computer or other suitable processing system that can carry out suitable computer-readable instructions that, when implemented, allow the controller to perform various different functions, such as feeding, heating, pressure control, deposition, etc.

A control system 10 can include a processor(s) and a memory. The processor(s) can be any known processing device. Memory can include any suitable computer-readable medium or media, including, but not limited to, RAM, ROM, hard drives, flash drives, or other memory devices. The memory can be non-transitory. Memory stores information accessible by processor(s), including instructions that can be executed by processor(s). The instructions can be any set of instructions that, when executed by the processor(s), cause the processor(s) to provide the desired functionality. For instance, the instructions can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to, application-specific circuits. Memory can also include data that may be retrieved, manipulated, or stored by processor(s).

The system can include a network interface for accessing information over a network. The network can include a combination of networks, such as Wi-Fi network, LAN, WAN, the Internet, cellular network, and/or other suitable network and can include any number of wired or wireless communication links. For instance, a computing device could communicate through a wired or wireless network with the modified atomic force microscope subsystem 30, the print head 20, the print bed 22, the pumps 6, 8, the temperature controllers T, the pressure controllers P, or any combination thereof.

The control system 10 can operate via the software to create a deposition pattern of nanoparticles deposited on a print bed 22 (or on a substrate located on the print bed 22). For instance, the design of a deposition pattern can be provided to a computer utilizing commercially available software. The deposition design can then be reproduced to complete the design of the deposited materials.

Drawing or “casting on” of the nano-scale particles carried in a flow onto the print bed 22 or a substrate located on the print bed 22 can be accomplished by various methods. For example, the flow carrying the nano-scale structures can be connected or adhered to a needle or other type of structure that can draw the extrudate from the print head 20 and apply it to the print bed 22. As an alternative, the tip of the modified atomic force microscope subsystem 30 of the print head 20 may be brought into contact with the print bed 22, or a substrate thereon, so as to contact the extrudate, whereby the extrudate adheres to the printing bed 22 or a substrate thereon creating an anchor for pulling the extrudate from the print head 20 and depositing the nano-scale material 23 as desired. In another embodiment, the nano-scale material 23 can be deposited on the print bed 22 with no continuous contact of an extrudate between the two.

In some embodiments, a patterned deposition of nanoparticles can be attained by the use of directed deposition and/or by the use of a substrate that has been processed to adhere to the particles with a preformed pattern. For instance, in one embodiment, the nano-scale structures can be treated to include a surface functionality, as described previously, and a substrate for deposition can be processed to include a binding agent for that functionality in a desired pattern. In another embodiment, an electric or magnetic field can be utilized to control and direct the deposition of nanoparticles that have been formed so as to react to the field in a predetermined fashion. For instance, magnetic particles can be directed to a magnetic surface (or a magnetic pattern formed on a surface) by use of a directed magnetic field. Other directed deposition techniques can include the use of patterned surfaces, e.g., SEM-FIB patterned surfaces.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A system comprising:
a first capillary having a first end and a second end and an inner diameter of about 1500 μm or less;
a second capillary;
a first mixing region;
a first pump configured to pump a first fluid through the first capillary in a direction from the first end to the second end of the first capillary;
a second pump configured to pump a second fluid through the second capillary in a direction from a first end to a second end of the second capillary;
a deposition subsystem, the deposition subsystem comprising:
a print head; and
a modified atomic force microscope subsystem, the modified atomic force microscope subsystem being in fluid communication with the first mixing region, the modified atomic force microscope subsystem comprising a cantilever and a modified atomic force microscope tip, the modified atomic force microscope tip comprising an outlet for depositing a nano-scale material.

2. The system of claim 1, wherein the modified atomic force microscope tip is formed from a non-reactive material.

3. The system of claim 1, wherein the modified atomic force microscope tip is formed at least partially from a ceramic material.

4. The system of claim 1, wherein the outlet of the modified atomic force microscope tip has a diameter from about 300 nm to about 15 μm.

5. The system of claim 1, wherein the system has a resolution of 500 nm or less.

6. The system of claim 1, wherein the system has a resolution of 200 nm or less.

7. The system of claim 1, wherein the print head comprises an end portion, the end portion configured to receive the modified atomic force microscope subsystem.

8. The system of claim 1, wherein the modified atomic force microscope subsystem is attached to the print head.

9. The system of claim 1, wherein the system further comprises a print bed, the print bed and the print head being moveable in relation to one another.

10. The system of claim 1, wherein the system further comprises a control system, the control system being in communication with the print head, the first pump, and the second pump.

11. The system of claim 1, wherein:
the modified atomic force microscope subsystem is in fluid communication with the first mixing region;
the outlet of the modified atomic force microscope tip has a diameter from about 300 nm to about 8 μm; and
the system has a resolution of 500 nm or less.

12. A method comprising:
flowing a first fluid carrying a first reagent through a first capillary;
flowing a second fluid carrying a second reagent through a second capillary, the first fluid and the second fluid passing into a first mixing region, the first reagent and second reagent interacting within the first mixing region to form a nano-scale material;
flowing the nano-scale material to a deposition subsystem, the deposition subsystem comprising a print head and a modified atomic force microscope subsystem, the modified atomic force microscope subsystem being in fluid communication with the first mixing region, the modified atomic force microscope subsystem comprising a cantilever and a modified atomic force microscope tip, the modified atomic force microscope tip comprising an outlet for depositing a nano-scale material; and
depositing the nano-scale material from the modified atomic force microscope subsystem to a print bed.

13. The method of claim 12, wherein the modified atomic force microscope subsystem has a resolution of 500 nm or less.

14. The method of claim 12, wherein the modified atomic force microscope subsystem has a resolution of 200 nm or less.

15. The method of claim 12, wherein the modified atomic force microscope tip is formed at least partially from a ceramic material.

16. The method of claim 12, wherein:
the modified atomic force microscope tip is formed at least partially from a ceramic material;
the outlet of the modified atomic force microscope tip has a diameter from about 300 nm to about 8 μm; and
the modified atomic force microscope subsystem has a resolution of 500 nm or less.

17. The method of claim 12, wherein the nano-scale material is deposited according to a patterned deposition.

18. The method of claim 17, wherein the patterned deposition is controlled by a control system in communication with the print head.

19. The method of claim 17, wherein the patterned deposition is controlled according to a pattern on the print bed.

20. The method of claim 17, wherein the patterned deposition is controlled by an external magnetic or electric field.
